(19) United States
(12) Patent Application Publication
(10) Pub. No.: US 2021/0344807 A1
(43) Pub. Date: Nov. 4, 2021

(54) ANTI-SLIP DEVICE AND IMAGE FORMING DEVICE

(71) Applicant: KONICA MINOLTA, INC., Tokyo (JP)

(72) Inventors: Hitomi KAWATA, Toyohashi-shi (JP); Junichi TANIMOTO, Toyokawa-shi (JP); Hiroshi TANIMOTO, Toyokawa-shi (JP); Masanobu TOMIYASU, Toyokawa-shi, (JP)

(73) Assignee: KONICA MINOLTA, INC., Tokyo (JP)

(21) Appl. No.: 17/199,553

(22) Filed: Mar. 12, 2021

(30) Foreign Application Priority Data
Apr. 30, 2020 (JP) 2020-079921

(51) Int. Cl. H04N 1/00; F16M 13/00; G03G 21/16

(52) U.S. Cl. CPC H04N 1/00562; G03G 21/1619; F16M 13/005

(57) ABSTRACT

An anti-slip device for preventing an installed image forming device from slipping on an installation surface. The anti-slip device includes an operation portion that can be moved by a user, a movable portion, and an anti-slip member. The movable portion has a bottom surface and moves in conjunction with movement of the operation portion to move from a first position to a second position above the first position. The anti-slip member is provided on the bottom surface of the movable portion and comes into contact with the installation surface when the movable portion is in the first position and separates from the installation surface when the movable portion is raised from the first position to the second position.

This application claims priority to Japanese Patent Application No. 2020-79921 filed Apr. 30, 2020, the contents of which are hereby incorporated herein by reference in their entirety.

### BACKGROUND

### Technical Field

The present disclosure relates to anti-slip devices in contact with an installation surface on which an image forming device is placed, for the purpose of preventing the image forming device from slipping.

### Description of Related Art

Among image forming devices such as printers, in order that an image forming device can be stably installed on an installation surface such as a floor surface, locations on a bottom surface of a body of some image forming devices (device body) are provided with installation feet at four corners of the device body (see Japanese Patent Application Publication No. 2009-214429).

After installation of an image forming device on an installation surface, when, for example, a user pulls out or pushes in a paper tray to exchange paper or clear a paper jam, or opens and closes an exterior cover, if the user applies a strong force and a force of movement of the paper tray or the exterior cover becomes too strong, the device body may slide on the installation surface and a position of the image forming device on the installation surface may shift.

As structures to prevent such shifting, an installation foot may be made of a material having a large frictional force with the installation surface or an anti-slip member made of a material having a large frictional force with the installation surface may be attached to a tip of the installation foot.

However, if an installation foot is made of a material having a large frictional force or an anti-slip member is attached to the installation foot before installation, then even if the device body is moved laterally to adjust position during installation, the anti-slip function makes it difficult to move the device body on the installation surface. On the other hand, if an anti-slip member is attached to an installation foot after installation, it is necessary to lift the device body upwards to separate the installation foot from the installation surface, making it difficult to attach the anti-slip member.

The above description is of attaching an anti-slip member to an installation foot, but the same problems may occur with a structure that does not have installation feet. In a structure that does not have installation feet, an anti-slip member is attached to a bottom of the device body, and if attached before installation, the device body is difficult to move during installation, and if attached after installation, the device body must be lifted.

### SUMMARY

An object of the present disclosure is to provide an anti-slip device and an image forming device for preventing slipping of the image forming device on an installation surface while also allowing for release of the anti-slip function by a simple operation.

To achieve at least the above object, an anti-slip device reflecting one aspect of the present disclosure is an anti-slip device for preventing an installed image forming device from slipping on an installation surface. The anti-slip device includes an operation portion that can be moved by a user, a movable portion, and an anti-slip member. The movable portion has a bottom surface and moves in conjunction with movement of the operation portion to move from a first position to a second position above the first position. The anti-slip member is provided on the bottom surface of the movable portion and comes into contact with the installation surface when the movable portion is in the first position and separates from the installation surface when the movable portion is raised from the first position to the second position.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 is a frontal view diagram schematically illustrating overall structure of an image forming device according to Embodiment 1.

FIG. 2 is a schematic perspective view diagram of the image forming device according to at least one embodiment.

FIG. 3 is an exploded perspective view diagram illustrating structure of an anti-slip device.

FIG. 4A is a diagram of a cross-section taken along a line E-E in FIG. 3, illustrating an operation member not being operated by a user, and FIG. 4B is a diagram of the same cross-section illustrating the operation member being operated by a user.

FIG. 5A is a diagram of a cross-section for describing a support mechanism of an operation member according to Embodiment 2, illustrating the operation member not being operated by a user, and FIG. 5B is a diagram of the same cross-section illustrating the operation member being operated by a user.

FIG. 6 is a diagram of a cross-section where solid lines illustrate an operation member not being operated by a user and two-dot dash lines illustrate the operation member being operated by a user.

FIG. 7 is a diagram of an enlargement of a cross-section illustrating an example structure of a locking mechanism of an operation member according to a modification.

FIG. 8 is a diagram of an enlargement of a cross-section illustrating an example structure of a handle portion according to a modification.

FIG. 9 is a schematic side-view diagram illustrating a structure of a bellcrank mechanism according to a modification.

### DETAILED DESCRIPTION

The following describes an anti-slip device and an image forming device provided with the anti-slip device as embodiments of the present disclosure, with reference to the drawings.

### Embodiment 1

### [1] Image Forming Device

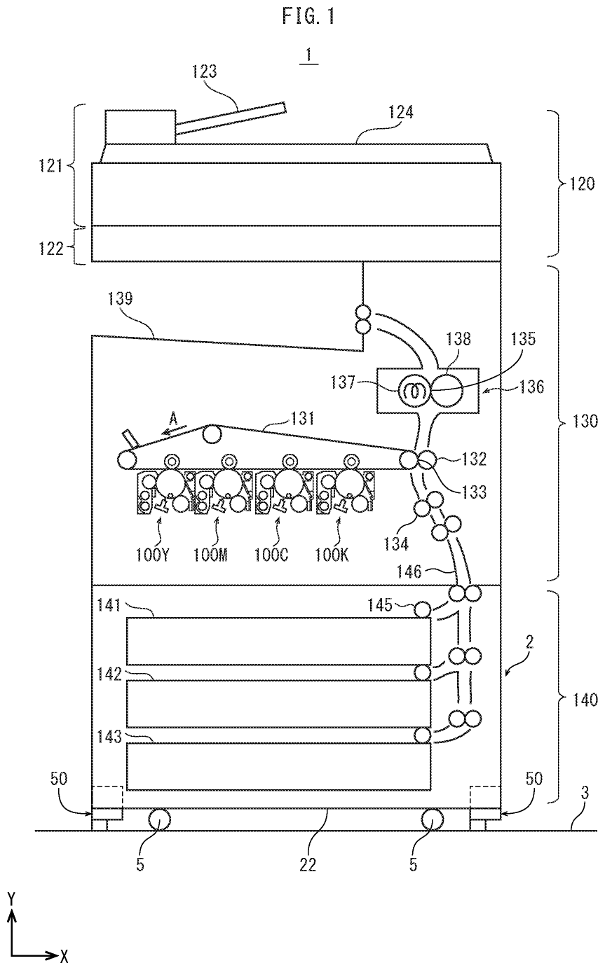

FIG. 1 is a frontal view diagram schematically illustrating overall structure of an image forming device 1. In FIG. 1, the X axis direction corresponds to a left-right direction and the Y axis direction corresponds to an up-down direction when the image forming device 1 is viewed from the front. A direction orthogonal to both the X axis and the Y axis may be referred to as a Z axis (depth direction).

The image forming device 1 includes an image reader 120, an image former 130, and a sheet feeder 140 in this order from top to bottom, as illustrated in FIG. 1.

The image reader 120 includes an automatic document feeder (ADF) 121 and a scanner 122, and reads images from documents using the scanner 122 while using the ADF 121 to convey the documents one sheet at a time from a document stack placed on a document tray 123 (sheet-through method). Documents that have been read are ejected onto an ejection tray 124. Further, the image reader 120 can also read an image from a document placed on platen glass (not illustrated) using the scanner 122 (platen set method).

The image former includes imaging units 100Y, 100M, 100C, 100K corresponding to colors yellow (Y), magenta (M), cyan (C), and black (K), used to form color images by an electrophotographic method, and an intermediate transfer belt 131.

The imaging units 100Y, 100M, 100C, 100K form toner images in corresponding Y, M, C, K colors based on mage data read by the image reader 12. Toner images in Y, M, C, K colors are transferred onto a position on the intermediate transfer belt 131.

The toner image on the position on the intermediate transfer belt 131 is conveyed by running the intermediate transfer belt 131 in a direction A, to a secondary transfer nip 133 where the intermediate transfer belt 131 and a secondary transfer roller 132 are in direct contact with each other.

The sheet feeder 140 includes sheet feed trays 141, 142, 143 that accommodate sheets. Sheets accommodated in the sheet feed tray 141 are picked up one sheet at a time by a pickup roller 145 and fed towards a conveyance path 146. A sheet fed to the conveyance path 146 is conveyed along the conveyance path towards the secondary transfer nip 133 by a conveyance roller 134. Similar sheet feed operations are executed by the sheet feed trays 142, 143.

Each of the sheet feed trays 141, 142, 143 is supported by a device body 2 such that it can be pulled in the depth direction out from a front side of the device. A user can replenish sheets when any one of the sheet feed trays 141, 142, 143 is pulled out, and after replenishing sheets, can push it in the depth direction towards a back side of the device to set it in the device body 2.

When a sheet conveyed on the conveyance path 146 passes through the secondary transfer nip 133, the toner image on the intermediate transfer belt 131 is transferred to the sheet by electrostatic action of the secondary transfer roller 132. The sheet onto which the toner image is transferred is conveyed towards a fixing unit 136.

The fixing unit 136 includes a heating roller 137 and a pressure roller 138 pressed against the heating roller 137. After a sheet passes through the secondary transfer nip 133, a toner image on the sheet is fixed by heat and pressure when passing through a fixing nip 135 where the heating roller 137 and the pressure roller 138 are in direct contact. The sheet that has passed through the fixing nip 135 is ejected outside and stored on an ejection tray 139.

Towards the bottom of the device body 2 of the image forming device 1 are provided anti-slip devices 50 for preventing the image forming device 1 from slipping relative to a surface (installation surface) 3 such as a floor or desk on which the image forming device 1 is installed. Here, the device body 2 is a structure that includes the image former 130, the sheet feeder 140, and housing accommodating same, and the image former 130 and the sheet feeder 140 constitute a printer that prints an image on a conveyed sheet.

Each of the anti-slip devices 50 includes a member that can switch between an anti-slip function and release thereof according to user operation. When the image forming device 1 is viewed in plan view, the anti-slip devices 50 are arranged near each of four corners of an approximately rectangular bottom of the device body 2.

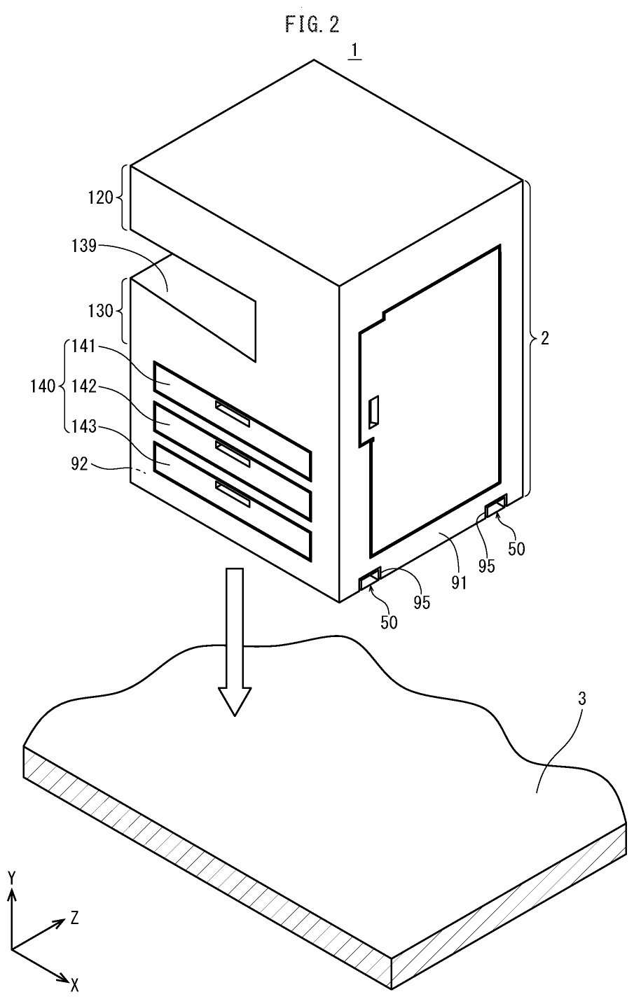

In FIG. 1, only two of the anti-slip devices 50 to the left and right sides of the device body 2 are illustrated. FIG. 2 is a schematic perspective view diagram of the image forming device 1, illustrating that two of notches 95 are provided along a bottom edge of an exterior cover 91 on the right side of the device, spaced apart from each other in the Z axis direction. The anti-slip devices 50 on the front-right side of the device and the anti-slip device 50 on the back-right side of the device are provided to these two of the notches 95. Although not shown, an exterior cover 92 on the left side of the device is also provided with two of the anti-slip devices 50 partially inside two more of the notches 95, arranged similarly. Structure of each of the anti-slip devices 50 is described under the next sub-heading.

Returning to FIG. 1, a plurality of casters 5 having rotatable rollers are provided on the bottom surface 22 of the device body 2, for the purpose of moving the image forming device 1 on the installation surface 3. In this example, there are four of the casters 5, arranged at corner positions closer to the center of the image forming device 1 in plan view than the anti-slip devices 50.

If a user performs an operation to release the anti-slip function of the anti-slip devices 50, the casters 5 of the image forming device 1 can move freely on the installation surface 3, such that installation position of the image forming device 1 can be adjusted without having to lift the device body 2.

### [2] Anti-Slip Device

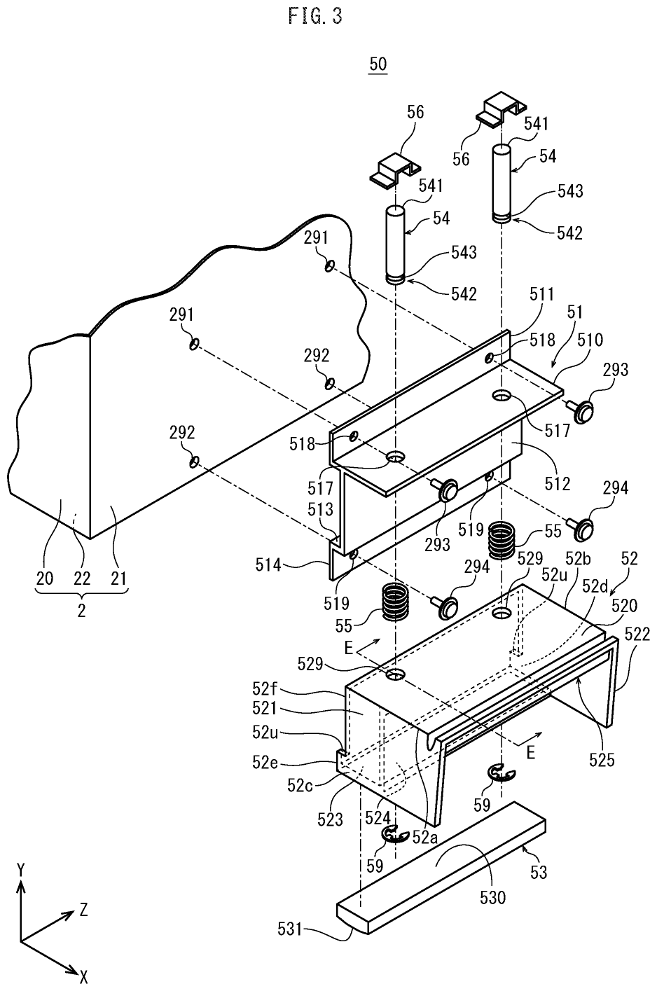

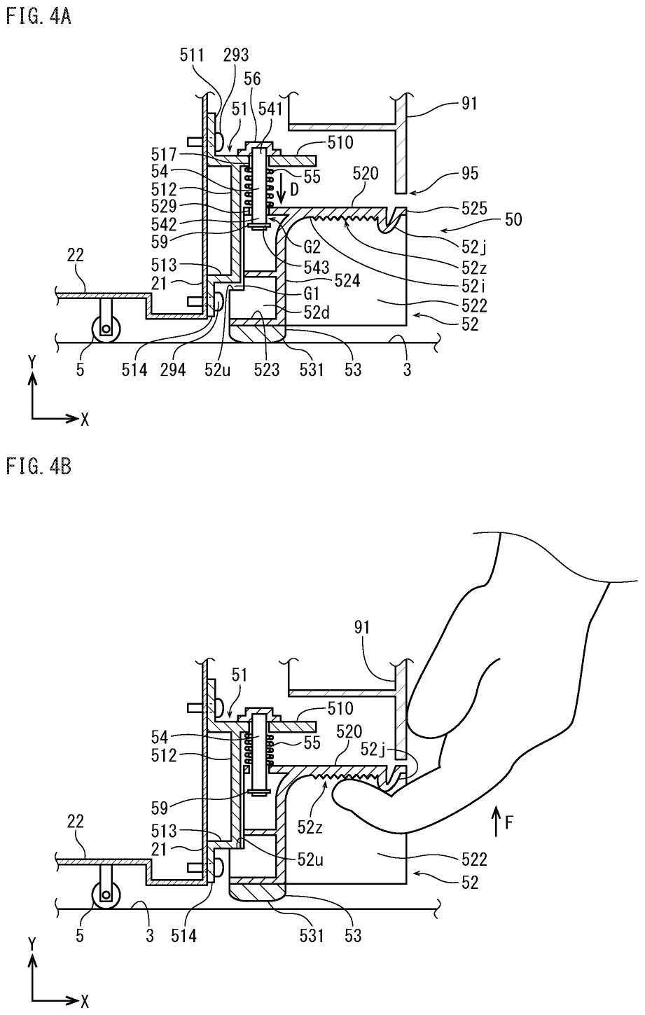

FIG. 3 is an exploded perspective view diagram illustrating structure of the front-right side one of the anti-slip devices 50, and FIG. 4A is a diagram of a cross-section of same, taken along line E-E in FIG. 3. In FIG. 3, reference signs 20, 21, 22 indicate front plate, right-side plate, and bottom surface of bottom plate portions of the device body 2 to which the anti-slip device 50 is attached. The front plate 20, the right-side plate 21, a left-side plate, and a back plate may also each be referred to as “side wall”.

As illustrated in FIG. 3 and FIG. 4A, the anti-slip device 50 includes a support bracket 51, an operating member 52, an anti-slip member 53, two guide bars 54, two compression coil springs 55, and two guide bar fixtures 56.

The support bracket 51 (support) is made of a metal such as iron or aluminum or a resin such as polycarbonate (PC), is attached to the right-side plate 21 close to the bottom surface 22 of the device body 2, and includes a horizontal plate 510 that is rectangular, a vertical plate 511 that rises vertically from a left edge of the horizontal plate 510, a vertical plate 512 that extends vertically down from an approximately central position along the X axis of the horizontal plate 510, a bend plate 513 that extends at a right-angle to the left from a bottom end of the vertical plate 512, and a vertical plate 514 that extends vertically down from a left edge of the bend plate 513.

Two screws 293 are inserted via two through-holes 518 spaced apart in the Z axis direction into the vertical plate 511 and screwed into two screw holes 291 provided in the right-side plate 21 of the device body 2. Two screws 294 are inserted via two through-holes 519 spaced apart in the Z axis direction into the vertical plate 514 and screwed into two more screw holes 292 provided in the right-side plate (side wall) 21 of the device body 2. When the vertical plates 511, 514 are screwed to the right-side plate 21 with screws 293, 294, the horizontal plate 510 takes a horizontal orientation.

The horizontal plate 510 is provided with two through-holes 517 that penetrate in the vertical direction at positions closer to a right edge of the horizontal plate 510 than the left edge and spaced apart in the Z axis direction. The guide bars 54 having substantially the same diameter as the through-holes 517 are inserted into the through-holes 517.

Each of the guide bars 54 is a rod-shaped member made of a metal such as iron or a resin such as polycarbonate (PC), and is fixed to the horizontal plate 510 by one of the guide bar fixtures 56 with an upper end portion 541 of the guide bar 54 protruding slightly above the horizontal plate 510.

In a state where the guide bars 54 pass through the through-holes 517 of the horizontal plate 510, the compression springs 55, and through-holes 529 through an operation portion 520 of the operation member 52, stop rings 59 are fitted to grooves 543 provided around lower ends 542 of the guide bars 54 to prevent the guide bars 54 from coming out of the through-holes 529. The guide bars 54 function as support members that guide and support the operation member 52 to allow vertical movement of the operation member 52 in the vicinity of the bottom of the device body 2.

The operation member 52 is disposed in the vicinity of a bottom of the device body 2. The operation member 52 is made of a resin such as polycarbonate, and in addition to the operation portion 520 that is a rectangular flat plate, includes a side 521 that is plate-shaped and extends down in the vertical direction from an edge 52a at a device front side of the operation portion 520, a side 522 that is plate-shaped and extends down in the vertical direction from an edge 52b at a device back side of the operation portion 520, a bottom 523 that is a rectangular flat plate connected to lower left portion 52c of the side 521 and a lower left portion 52d of the side 522 (see FIG. 4A), and a connector 524 that is plate-shaped and connects the bottom 523 to the operation portion 520, as illustrated in FIG. 3.

Here, the sides 521, 522 have the same size and shape as each other, and a left edge 52f of the side 521 has a shape such that a lower portion 52e protrudes to the left with a step 52u between the lower portion 52e and an upper portion. The step 52u is similarly formed on the side 522. The bottom 523 is laid down between the sides 521, 522 in a horizontal orientation, and the anti-slip member 53 is provided to a bottom surface of the bottom 523.

The anti-slip member 53 is a rectangular plate-shaped member made of a material having elasticity, such as rubber, and a top surface 530 thereof is attached by adhesive or the like in surface contact with the bottom surface of the bottom 523. The rubber used for the anti-slip member 53 is a material having a high frictional force (friction resistance) with the installation surface 3 such as urethane rubber, silicone rubber, or fluororubber, and according to at least one embodiment has a hardness (Japanese Industrial Standard (JIS) A) of 70 or less. As long as the anti-slip member 53 has a high coefficient of friction, it is not limited to the above materials and may be a material other than rubber.

According to this structure, as illustrated in FIG. 4A, when a user is not operating the operation member 52 (the user's hand is not touching the operation portion 520: non-operation state), a restoring force of the compression coil spring 55 acts downwards (direction of arrow D) on the operation portion 520 of the operation member 52, pressing a bottom surface 531 of the anti-slip member 53 against the installation surface 3. Due to this pressing force, a large frictional force acts between the anti-slip member 53 and the installation surface 3, causing the anti-slip function of the image forming device 1 with respect to the installation surface 3 to be exhibited.

In the non-operation state illustrated in FIG. 4A, the step 52u of the operation member 52 is separated from the bend plate 513 of the support bracket 51 located above the step 52u, forming a gap G1 (of, for example, 5 mm) between the step 52u and the bend plate 513. Further, a gap G2 (of, for example, 3 mm to 5 mm) is also formed between the stop rings 59 fitted to the lower end of the guide bars 54 and a bottom surface of the operation portion 520 of the operation member 52. The gap G2 is provided so the stop rings 59 do not interfere with downward movement of the operation member 52 pressed by the restoring force of the compression coil springs 55. Dimensions of each member are predefined such that the gaps G1 and G2 are formed.

When a user operates the operation member 52, the user's fingers push up a lower surface 52i of the operation portion 520 in a direction of an arrow F (operation state), as illustrated in FIG. 4B. An uneven portion 52z is formed in a region of the lower surface 52i of the operation portion 520 that is central in the left-right (X axis) direction, in order to prevent the user's fingers from slipping. Further, a right end portion 525 of the operation portion 520 includes a hook portion 52j that protrudes downwards such that the user's fingers can easily catch onto the hook portion 52j. Providing the uneven portion 52z and the hook portion 52j improves operability for users.

A user pushing upwards causes an upward force (operation direction force) to act on the operation member 52, contracting the compression coil spring 55, and the operation member 52 is pushed upwards along the vertical plate 512 of the support bracket 51 against the restoring force of the compression coil spring 55. As a result, the bottom surface 531 of the anti-slip member 53 is separated from the installation surface 3. This separation releases the anti-slip action of the anti-slip member 53.

The operation member 52 is formed by integrally molding the operation portion 520, the sides 521, 522, the bottom 523, and the connector 524. The operation portion 520 is a reception unit that receives a manual operation from a user, and moves in the operation direction (upwards) according to the manual operation from the user. The sides 521, 522, the bottom 523, and the connector 524 constitute a movable member that moves up and down with the operation portion 520, and the anti-slip member 53 is attached to a bottom surface of the movable member (bottom surface of the bottom 523).

The position of the operation member 52 (movable member) when the anti-slip member 53 is in contact with the installation surface 3 (anti-slip is active) is referred to as a first position, and the position of the operation member 52 when the anti-slip member 53 is separated from the installation surface 3 (anti-slip is released) is referred to as a second position. The second position is above the first position.

When the anti-slip is released, the image forming device 1 is free to move laterally on the installation surface 3 via the casters 5, and therefore a user can easily adjust the position of the image forming device 1 by applying a force in the desired direction to the device body 2.

When the operation member 52 is pushed up and the step 52u comes into contact with the bend plate 513 of the support bracket 51, or in other words when the gap G1 becomes zero, a push operation against the restoring force of the compression coil springs 55 ends.

When the step 52u of the operation member 52 is in contact with the bend plate 513 of the support bracket 51, and a user continues to push up the operation member 52, the upward force is transmitted from the support bracket 51 to the device body 2, and when this force becomes greater than a portion of total weight of the image forming device 1 acting on the front right one of the casters 5 (in Newtons (N)), the front-right part of the device body 2 is lifted. Accordingly, it can be said that the operation member 52 functions not only in preventing the image forming device 2 from slipping and in releasing the anti-slip action, but also functions as a handle for lifting the device body 2.

When the user releases the operation member 52, the compressed compression coil springs 55 expand, the downward restoring force of the compression coil springs 55 pushes down the operation member 52, and the anti-slip member 53 moves from the second position to the first position, the bottom surface 531 of the anti-slip member 53 is pressed against the installation surface 3, and the anti-slip works again.

The above is a description of structure of the front-right one of the anti-slip devices 50, but the other three anti-slip devices 50 have the same structure and therefore are not described in detail here.

As described above, according to Embodiment 1, in a non-operation state in which a user is not operating the operation member 52, the anti-slip member 53 in the first position is pressed against the installation surface 3 to generate an anti-slip action, and when a user pushes up the operation member 52, the operation member 53 together with the anti-slip member 53 separate from the installation surface 3 and move to the second position, releasing the anti-slip action. As a result, the anti-slip action is achieved, and a user can perform a simple operation to easily release it without needing to lift up the device body 2.

### Embodiment 2

An example structure has been described according to Embodiment 1, in which the entirety of the operation member 52 is supported to be slidable in the vertical direction. Embodiment 2 is different from Embodiment 1, in that the operation member is supported to be swingable in the vertical direction.

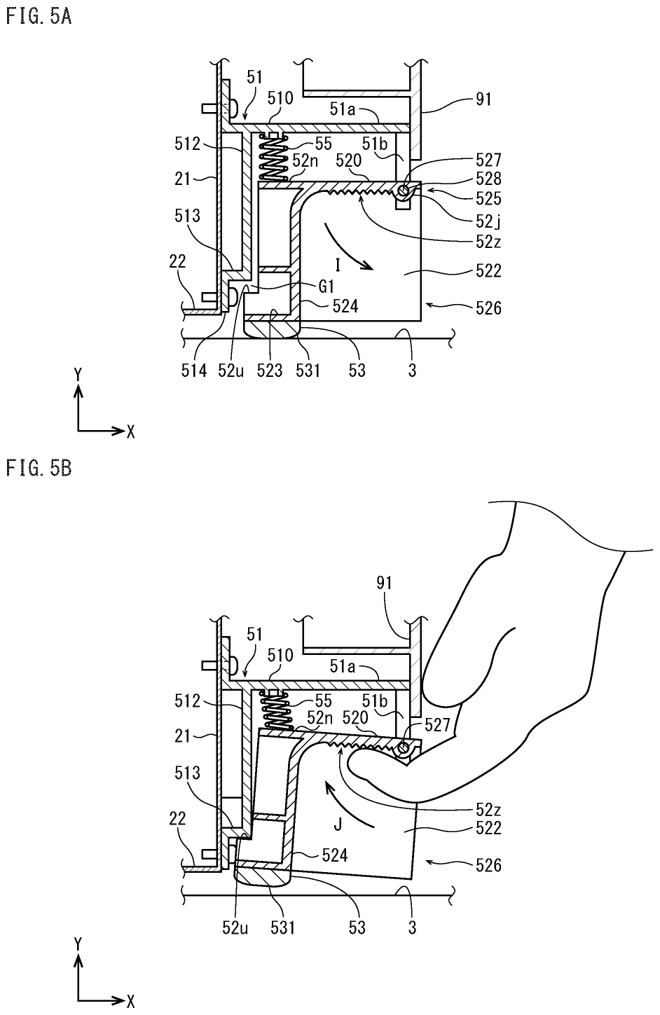

FIG. 5A is a cross-section diagram for explaining a support mechanism of the operation member 526 according to Embodiment 2, in which the same components as in Embodiment 1 are designated by the same reference signs. Description of those same components is not repeated below.

As illustrated in FIG. 5A, the operation member 526 is similar to the operation member 52 of Embodiment 1, but a through-hole 528 in the Z axis direction is provided in the hook portion 52j of the right end portion 525, and a support shaft 527 is inserted through the through-hole 528.

Both ends of the support shaft 527 are supported by support pieces 51b that hang down from both ends in the Z axis direction of an extension 51a that extends the right end of the horizontal plate 510 of the support bracket 51 (in FIG. 5A, only the device back side support piece 51b is illustrated, but a device front side support piece 51b is also provided). The operation member 526 is supported such that a left end 52n (to which the anti-slip member 53 is fixed) can swing in the vertical direction about the support shaft 527 of the right end portion 525 in a direction indicated by an arrow I and an opposite direction (indicated by an arrow J in FIG. 5B).

Further, according to Embodiment 2, the guide bars 54 of Embodiment 1 are not included, upper ends of the compression coil springs 55 are connected to the lower surface of the horizontal plate 510 so as not to detach, and lower ends of the compression coil springs 55 are connected to the left end 52n of the operation portion 520 so as not to detach.

According to this structure, in a non-operated state as illustrated in FIG. 5A, the restoring force of the compression coil springs 55 acts on the left end 52n of the operation member 526, the left end 52n swings about the support shaft 527 in the direction of the arrow I (downwards), and the bottom surface 531 of the anti-slip member 53 is pressed against the installation surface 3. This pressure causes the anti-slip action.

When a user operation starts, as illustrated in FIG. 5B, when a user's fingers push up the lower surface 52i of the operation portion 520, the compression coil springs 55 contract, the left end 52n of the operation portion 520 of the operation member 526 swings about the support shaft 527 in the direction of the arrow J (upwards), and the bottom surface 531 of the anti-slip member 53 is separated from the installation surface 3, releasing the anti-slip action.

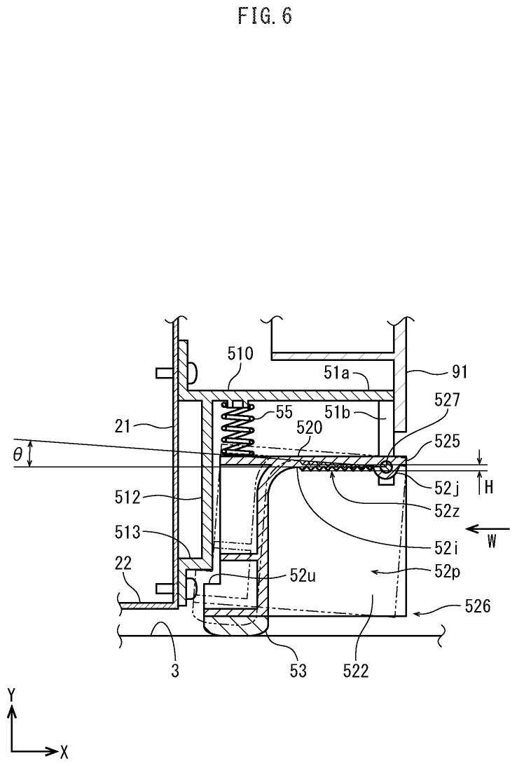

FIG. 6 is a diagram of a cross-section where solid lines illustrate the operation member 526 not being operated by a user and two-dot dash lines illustrate the operation member 526 being operated by a user, and shows how the operation member 526 moves by an angle θ about the support shaft 527 due to the operation by the user.

When the operation member 526 rotates by the angle θ, the lower surface 52i of the operation portion 520 becomes an inclined surface at the angle θ from the horizontal, and a left end of the uneven surface 52z of the lower surface 52i of the operation portion 520 moves by a distance H in the vertical direction with respect to the support shaft 527.

A user inserts their fingers into a space 52p below the operation portion 520 from a direction of an arrow W, and with fingertips performs an operation to lift the uneven portion 52z of the operation portion 520 located further to the left than the right end portion 525 (end portion) that is provided with the support shaft 527.

During this lifting operation, the lower surface 52i of the operation portion 520 becomes inclined at the angle θ, the uneven portion 52z moves upwards with respect to the support shaft 527, and the fingertips move up by only the distance H. As a result, the uneven portion 52z and the hook portion 52j of the operation portion 520 are grasped by the entirety of each finger, which makes it easier for the user to firmly grip the operation portion 520 and improves lifting operability.

### <Modifications>

Descriptions of embodiments are provided above, but the present disclosure is of course not limited to the embodiments described above, and includes the following modifications.

(1) According to at least one embodiment, a structure is described in which the anti-slip devices 50 are attached in the vicinity of four corners of the device body 2, but the number of anti-slip devices 50 is not limited to four, and one or more of the anti-slip devices 50 may be attached. For example, when a large force acts on the device body 2 in the front-back direction of the device when a user pulls out and pushes in the paper feed trays 141, 142, 143 and the position of the device body 2 on the installation surface 3 is easy to shift, one anti-slip device 50 can be attached to either the front side or back side of the device body 2, or an anti-slip device 50 can be attached to the front side and another anti-slip device 50 can be attached to the back side of the device body 2.

Further, when the image forming device 1 is viewed from the front (FIG. 1), when the position of the center of gravity of the image forming device 1 is biased to the right along the X axis, the left edge of image forming device 1 is lighter than the right edge, for example.

On the other hand, if the anti-slip devices 50 are not attached at all, the greater the weight (corresponding to the normal force) of the device body acting on the installation surface 3 from portion of the image forming device 1 in contact with the installation surface 3, here the casters 5, the greater the frictional force generated between the image forming device 1 and the installation surface 3.

In the above example, the left end of the image forming device 1 is lighter than the right end, and therefore the left end has less frictional force with the installation surface 3, and it be said that the left end is easier to move when pulling out or pushing in the paper feed trays 141, 142, 143. With such a structure, the image forming device 1 can be prevented from slipping on the installation surface 3 by positioning the anti-slip device 50 on the left side of the device that is easier to move. When the position of the center of gravity of the image forming device 1 is biased to the left of the center, the anti-slip device 50 can be positioned on the right side of the device.

Further, when the image forming device 1 is viewed from the side, if the position of the center of gravity of the image forming device 1 is biased to the rear of the center, the anti-slip device 50 can be positioned in front of the center of the device. When the position of the center of gravity is biased to the front, the anti-slip device 50 can be positioned behind the center of the device.

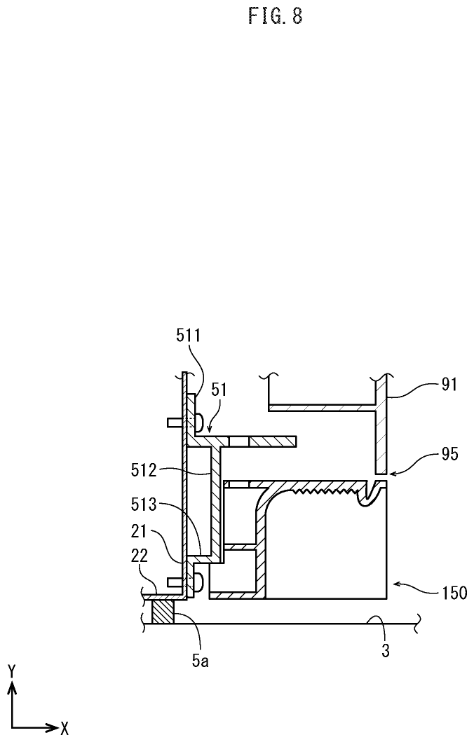

Further, when there are a total of four locations in the vicinity of corners of the device where the anti-slip devices 50 can be provided, a grip 150 as illustrated in FIG. 8 can be disposed in one to three of the locations where the anti-slip devices 50 are not provided.

As illustrated in FIG. 8, the grip 150 is composed of only the support bracket 51 and the operation member 52 as support members among the components of the anti-slip devices 50, and the operation member 52 is fixed to the support bracket 51 by adhesives, screws, or the like. In FIG. 8, an example is illustrated in which an installation foot 5a is provided on the bottom 22 of the device body 2 instead of the caster 5.

The grip 150 is separated from the installation surface 3 and therefore does not have an anti-slip function and is used as a handle when lifting the device body 2. Some components of the anti-slip device 50 can be used as a grip, and therefore there is no need for a new design or management for the grip. According to at least one embodiment, the support bracket 51 and the operation member 52 are a single integrated part.

According to at least one embodiment, the operation member 52 is attached to the right-side plate 21 (side wall of a bottom portion of the device body 2), but the position of the operation member 52 is not limited to this. For example, the operation member 52 may be attached to the left-side plate, the front plate 20, or the back plate (side walls of a bottom portion of the device body 2).

(2) According to at least one embodiment, the anti-slip member 53 is adhered to a bottom surface of the bottom 523 of the operation member 52, but the present disclosure is not limited to this. It suffices that an anti-slip portion having an anti-slip function is provided on a bottom surface of the operation member 52. For example, according to at least one embodiment, instead of adhering the anti-slip member 53, an upper half of an anti-slip member is embedded in the bottom 523 of the operation member 52 and a lower half is exposed.

(3) According to at least one embodiment, the casters 5 are arranged on the bottom 22 of the device body 2, but the present disclosure is not limited to this, and installation feet may be provided instead of casters. In a structure in which an installation foot is provided, frictional force generated between the anti-slip member 53 and the installation surface 3 is larger than the frictional force generated between the installation foot and the installation surface 3, and shapes and/or material of the installation foot that slip easily with respect to the installation surface 3 are used.

(4) According to at least one embodiment, the anti-slip member 53 is pressed against the installation surface 3 by the restoring force of the compression coil springs 55 that are elastic bodies, but the present disclosure is not limited to this. As an elastic body, a leaf spring or the like can be used, for example. Further, instead of using an elastic body, according to at least one embodiment, a weight (not illustrated) is attached to the operation member 52, and the anti-slip member 53 is pressed against the installation surface 3 by the weight. The weight corresponds to the force exerted by the biasing member. Further, instead of a weight, according to at least one embodiment a structure is adopted in which mass of the operation member 52 itself is increased and the weight of the operation member 52 is used.

In any case, it is necessary that the operation member 52 on which the downward pressing force acts can be lifted even by a weak user, and the spring constant of the compression coil springs 55, the mass of the weight, etc., are determined in advance taking into account magnitude of upward operation force by a user.

For example, in a structure having a number of the casters 5 or installation feet, a restoring force of the compression coil springs 55 (biasing force P in Newtons (N)) can be determined to be within a range smaller than a value obtained by dividing a weight Q (N) of the image forming device 1 by the number of the casters 5 or the installation feet.

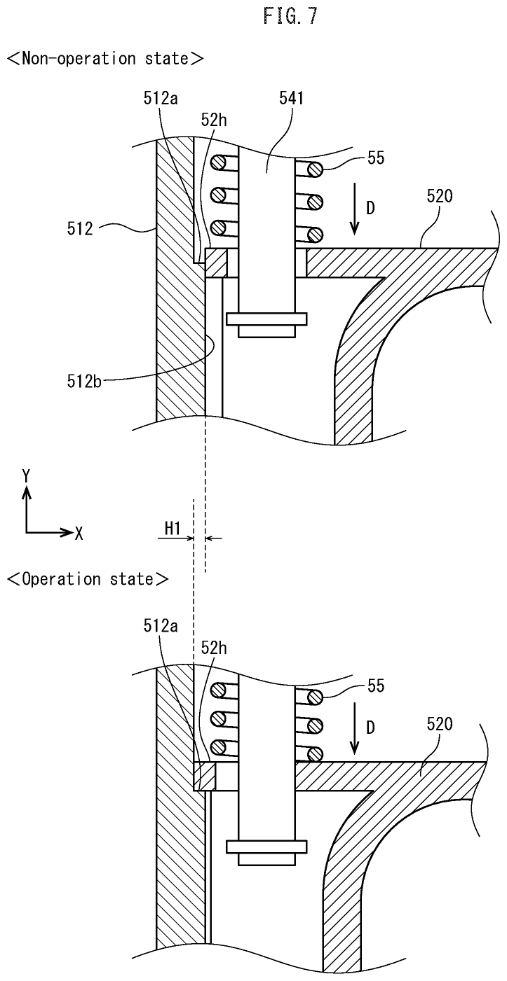

(5) According to Embodiment 1, the operation member 52 is supported so as to be movable in the vertical direction. According to at least one embodiment, a locking mechanism is provided that locks and unlocks the operation member 52 such that when a user lifts the operation member 52, the operation member 52 is locked at the lifted position (second position), and subsequently when the lock is released, the operation member 52 moves down to the first position. FIG. 7 illustrates an example of such a locking mechanism.

Specifically, FIG. 7 is a diagram of an enlargement of a cross-section illustrating a portion of the operation portion 520 of the operation member 52 and a portion of the vertical plate 512 of the support bracket 51, where a protrusion 52h is provided at the left end of the operation portion 520 and a step 512a is provided at a position of the vertical plate 512 in the vertical direction.

When the operation member 52 is not operated by a user, the operation member 52 is in the first position, the protrusion 52h of the operation portion 520 is located slightly below the step 512a of the vertical plate 512 in contact with a surface 512b of the vertical plate 512.

When a user lifts the operation member 52 with fingers and pushes the operation member 52 slightly backwards (negative direction of the X axis) by a distance H1, the protrusion 52h of the operation portion 520 moves over the step 512a of the vertical plate 512 and engages. An engaged state is the second position of the operation member 52. When the user releases their fingers from the operation member 52 at the second position, the downward restoring force of the compression coil springs 55 acts on the operation member 52, but the step 512a of the vertical plate 512 acts as a stopper and prevents the operation member 52 from moving downwards due to the restoring force of the compression coil springs 55. That is, the operation member 52 is locked in the second position. The step 512a of the vertical plate 512 constitutes a lock that locks the operation member 52 at the second position.

To release the lock, the user may pull out the operation member forwards (positive direction of the X axis) by a distance H1 with their fingers. As a result, the protrusion 52h of the operation portion 520 is separated and disengaged from the step 512a of the vertical plate 512, and the operation member 52 is pushed down by the downward restoring force of the compression coil springs 52 to return to the first position.

The locking mechanism is not limited to the example above. For example, the locking mechanism can be a latch mechanism such as that of a knock-type ballpoint pen.

(6) According to at least one embodiment, the operation member 52 is the operation portion 520, the sides 521, 522, the bottom 523, etc., integrally molded, but the operation member 52 is not limited to this. For example, according to at least one embodiment, the operation portion 520 and the bottom 523 provided with the anti-slip member 53 are separate bodies, and when the operation portion 520 is operated by a user and moves in the operation direction (from down to up), the bottom 523 as a movable portion moves from the first position to the second position together with the operation portion 520.

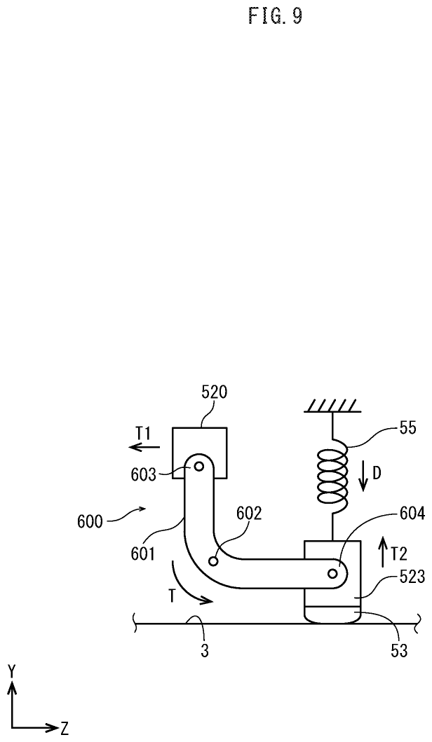

For example, a bellcrank mechanism 600 as illustrated in FIG. 9 can be adopted. The bellcrank mechanism 600 includes an L-shaped bellcrank 601 and a shaft 602 provided to a bent portion centrally located in a longitudinal direction of the bellcrank 601 that supports the bellcrank 601 so as to be swingable in a direction indicated by an arrow T, and an opposite direction. The operation portion 520 is attached to a longitudinal end 603 of the bellcrank 601, and the bottom 523, which is a movable portion, is attached to another longitudinal end 604 of the bellcrank 601.

When a user pushes or pulls the operation portion 520 in a lateral direction (direction of arrow T1), the bellcrank 601 swings in the direction of the arrow T against the restoring force of the compression coil spring 55 in a direction of arrow D, such that the bottom 523 moves from the first position to the second position in a direction of arrow T2 and the anti-slip member 53 separates from the installation surface 3. The lateral force due to user operation is converted into vertical force by the bellcrank mechanism 600. Another conversion mechanism may be used. For example, a crank or the like that converts force in a rotation direction by a rotation operation applied to the operation portion 520 from a user into a force in the vertical direction.

(7) According to at least one embodiment, the image forming device 1 is described as a color copier, but the image forming device 1 is not limited to this. The image forming device 1 can be image forming devices such as printers and facsimile machines.

Further, content of the embodiments and modifications described above may be combined wherever possible.

### <Review>

The content of the embodiments and modifications described above illustrate one aspect for solving at least a technical problem described under the header [Description of Related Art], and can be summarized as follows.

According to at least one embodiment, an anti-slip device reflecting one aspect of the present disclosure is an anti-slip device for preventing an installed image forming device from slipping on an installation surface. The anti-slip device includes an operation portion that can be moved by a user, a movable portion, and an anti-slip member. The movable portion has a bottom surface and moves in conjunction with movement of the operation portion to move from a first position to a second position above the first position. The anti-slip member is provided on the bottom surface of the movable portion and comes into contact with the installation surface when the movable portion is in the first position and separates from the installation surface when the movable portion is raised from the first position to the second position.

According to at least one embodiment, the operation portion and the movable portion are integrated, the integrated operation portion and movable portion is referred to as an operation member, and the operation member is disposed in the vicinity of a bottom of a body of the image forming device.

According to at least one embodiment, the anti-slip device further includes a support that supports the operation member while allowing vertical movement of the operation member, the support being attached to a side wall of a bottom portion of the body of the image forming device.

According to at least one embodiment, the operation member further includes a biasing member that applies a downward force to the operation member.

According to at least one embodiment, the biasing member is an elastic body.

According to at least one embodiment, the support member includes a guide that guides the operation member in the vertical movement.

According to at least one embodiment, the support allows a movable portion end of the operation member to move up and down by swinging about a support shaft provided to an operation portion end of the operation member.

According to at least one embodiment, the movable portion end and the operation portion end of the operation member have a positional relationship in which the movable portion end is closer to the side wall than the operation portion end is.

According to at least one embodiment, a number of installation feet are provided on the bottom of the body of the image forming device, and the downward force in Newtons is smaller than a value obtained by dividing the weight in Newtons of the image forming device by the number of the installation feet.

According to at least one embodiment, an installation foot is provided on the bottom of the body of the image forming device, and a frictional force generated between the anti-slip member and the installation surface is larger than a frictional force generated between the installation foot and the installation surface.

According to at least one embodiment, the anti-slip device further includes a locking portion that locks the movable portion in the second position when the movable portion moves from the first position to the second position.

According to at least one embodiment, an image forming device reflecting one aspect of the present disclosure is an image forming device including a body that forms an image on a sheet, and one or more anti-slip devices for preventing the image forming device from slipping on an installation surface, the one or more anti-slip devices provided to one or more defined locations of a bottom portion of the body. Each of the one or more anti-slip devices includes an operation portion that can be moved by a user, a movable portion, and an anti-slip member. The movable portion has a bottom surface and moves in conjunction with movement of the operation portion to move from a first position to a second position above the first position. The anti-slip member is provided on the bottom surface of the movable portion and comes into contact with the installation surface when the movable portion is in the first position and separates from the installation surface when the movable portion is raised from the first position to the second position.

According to at least one embodiment, when a position of the center of gravity of the body is biased towards one end in a left-right direction or front-back direction of the body viewed from the front of the body, the one or more defined locations are in the vicinity of an opposite end in the left-right direction or the front-back direction of the bottom portion of the body.

According to the structures described above, the anti-slip member comes into contact with the installation surface on which the image forming device is installed when the movable portion is in the first position, in order to prevent the image forming device from slipping, a user can release the anti-slip by simply operating the operation portion to move the movable portion from the first position to the second position without needing to lift the body of the image forming device.

Although one or more embodiments of the present invention have been described and illustrated in detail, the disclosed embodiments are made for the purposes of illustration and example only and not limitation. The scope of the present invention should be interpreted by the terms of the appended claims

What is claimed is:

1. An anti-slip device for preventing an installed image forming device from slipping on an installation surface, the anti-slip device comprising:
an operation portion that can be moved by a user;
a movable portion that has a bottom surface, the movable portion moving in conjunction with movement of the operation portion to move from a first position to a second position above the first position; and
an anti-slip member provided on the bottom surface of the movable portion that comes into contact with the installation surface when the movable portion is in the first position and separates from the installation surface when the movable portion is raised from the first position to the second position.

2. The anti-slip device of claim 1, wherein
the operation portion and the movable portion are integrated, the integrated operation portion and movable portion is referred to as an operation member, and the operation member is disposed in the vicinity of a bottom of a body of the image forming device.

3. The anti-slip device of claim 2, further comprising
a support that supports the operation member while allowing vertical movement of the operation member, the support being attached to a side wall of a bottom portion of the body of the image forming device.

4. The anti-slip device of claim 3, wherein
the operation member further comprises a biasing member that applies a downward force to the operation member.

5. The anti-slip device of claim 4, wherein
the biasing member is an elastic body.

6. The anti-slip device of claim 3, wherein
the support member includes a guide that guides the operation member in the vertical movement.

7. The anti-slip device of claim 3, wherein
the support allows a movable portion end of the operation member to move up and down by swinging about a support shaft provided to an operation portion end of the operation member.

8. The anti-slip device of claim 7, wherein
the movable portion end and the operation portion end of the operation member have a positional relationship in which the movable portion end is closer to the side wall than the operation portion end is.

9. The anti-slip device of claim 4, wherein
a number of installation feet are provided on the bottom of the body of the image forming device, and
the downward force in Newtons is smaller than a value obtained by dividing the weight in Newtons of the image forming device by the number of the installation feet.

10. The anti-slip device of claim 1, wherein
an installation foot is provided on the bottom of the body of the image forming device, and
a frictional force generated between the anti-slip member and the installation surface is larger than a frictional force generated between the installation foot and the installation surface.

11. The anti-slip device of claim 1, further comprising
a locking portion that locks the movable portion in the second position when the movable portion moves from the first position to the second position.

12. An image forming device comprising:
a body that forms an image on a sheet; and
one or more anti-slip devices for preventing the image forming device from slipping on an installation surface, the one or more anti-slip devices provided to one or more defined locations of a bottom portion of the body, each of the one or more anti-slip devices comprising:
an operation portion that can be moved by a user;
a movable portion that has a bottom surface, the movable portion moving in conjunction with movement of the operation portion to move from a first position to a second position above the first position; and
an anti-slip member provided on the bottom surface of the movable portion that comes into contact with the installation surface when the movable portion is in the first position and separates from the installation surface when the movable portion is raised from the first position to the second position.

13. The image forming device of claim 12, wherein
when a position of the center of gravity of the body is biased towards one end in a left-right direction or front-back direction of the body viewed from the front of the body, the one or more defined locations are in the vicinity of an opposite end in the left-right direction or the front-back direction of the bottom portion of the body.
